(19) United States
(12) Patent Application Publication
(10) Pub. No.: US 2012/0099986 A1
(43) Pub. Date: Apr. 26, 2012

(54) LIQUID SEAL, SHAFT SEAL APPARATUS AND PUMP APPARATUS USING THE SAME

(75) Inventors: Yoshitake HISADA, Kariya-shi (JP); Takeshi Fuchida, Kariya-shi (JP)

(73) Assignee: ADVICS CO., LTD., Kariya-shi (JP)

(21) Appl. No.: 13/277,668

(22) Filed: Oct. 20, 2011

(30) Foreign Application Priority Data
Oct. 20, 2010 (JP) 2010-235672

(51) Int. Cl. F04D 29/10; F16J 15/32

(52) U.S. Cl. 415/231; 277/549; 277/560

(57) ABSTRACT

A liquid seal has an annular lip portion and an annular fixing portion to be fixed to an inner peripheral surface of a shaft hole, in which the lip portion is connected to the fixing portion and is provided so that a tip thereof is extended in an axial direction, a spring pressing a seal lip against an outer periphery of the rotation shaft is fitted onto the lip portion. The seal lip forms a mountain shape in which an edge of the apex in the cross section, which is cut along a plane passing through a center axis of the seal, protrudes to the inner diameter side, and the pressure center of the seal lip due to the spring is disposed between the tip side of the lip portion further than the edge of the apex of the mountain of the seal lip in the axial direction.

### BACKGROUND

The present invention relates to a liquid seal that is used for sealing a gap between relatively rotating members, for example, a gap between a rotation shaft and a member passing through the same, a shaft seal apparatus and a pump apparatus using the same.

Among known liquid seals that seal an outer periphery of a rotation shaft, for example, there is a liquid seal disclosed in Japanese Patent No. 3180285 described below. In the liquid seal disclosed in Japanese Patent No. 3180285, a seal lip formed of an elastic body is attached to an attachment annulus that is fitted into a shaft hole.

The seal lip is configured so that a proximal end thereof is fixed to an inner diameter portion of the attachment annulus, and a tip (a free end) side is axially extended from the proximal end. Furthermore, the inner diameter side of the seal lip is configured so that an edge of the apex is formed in a mountain shape protruded to the inside of a diameter direction, an edge circumference of the apex of the mountain is pressed to the rotation shaft, and the sealing of the outer periphery of the rotation shaft is performed.

The liquid seal of Japanese Patent No. 3180285 is used so that the tip of the seal lip is disposed at a liquid chamber side (a sealing fluid side) and the proximal end of the seal lip is disposed at an atmosphere side (a counter sealing fluid side), respectively. Herein, the disposition thereof is called a forward posture, and a posture of an opposite direction thereof is called a backward posture.

It is known that, when the liquid seal of Japanese Patent No. 3180285 is used in the forward posture, air is slightly sucked from the atmosphere side to a seal interface, oil existing between sliding-contact surfaces as an oil film is circulated from the atmosphere side to the liquid chamber side in the sliding-contact surface and is circulated from the liquid chamber side to the atmosphere side, the sealing of fluid is stabilized, and when the liquid seal is used in the backward posture of the opposite direction thereof, fluid leaks from the liquid chamber side to the atmosphere side. This is explained in Japanese Patent No. 3180285 and in a specialized text as a sealing mechanism of the liquid seal.

Meanwhile, as a pump apparatus of the power driving used in brake liquid pressure control apparatus, for example, there is an apparatus disclosed in JP-A-2007-278086, and in the pump apparatus, a liquid seal with a lip as shown in FIG. 9 is used in the backward posture.

In order to prevent the leaking of oil (a brake fluid) introduced into an inner portion (a suction chamber communicating a suction port of the pump) of a housing to the outside, in the pump apparatus of JP-A-2007-278086, a first seal portion and a second seal portion are jointly provided to perform a double seal.

The first seal portion is sealed so that the pressure of the pump suction port is not directly applied to the second seal portion. When fluid leaks from the first seal portion, the brake fluid is stored in a middle chamber formed between the first seal portion and the second seal portion. The leakage from the middle chamber of the brake fluid leaked to the middle chamber is hindered by the second seal portion.

The second seal portion is configured by mounting the liquid seal with the general lip as shown in FIG. 9 in the backward posture.

The liquid seal 1 with the lip of FIG. 9 includes an annular portion 2 that is brought into contact with the outer periphery of a rotation shaft (not shown) in a freely sliding manner, and an annular fixing portion 3 that is pressed and fixed to the inner peripheral surface of the rotation shaft inserting shaft hole, and a proximal end of the lip portion 2 is connected to an inner diameter side of the fixing portion 3.

Furthermore, the apparatus has a configuration in which an annular spring 7 is fitted onto the lip portion 2, and the lip portion 2 of the spring 7 is pressed to the rotation shaft, thereby increasing the contact surface pressure of the lip portion 2 facing the rotation shaft. The spring 7 is in the proximal end side of the lip portion 2 further than the center (an edge 4c of the apex of the mountain) of the axial direction of the seal lip 4 having a cross section of a mountain shape provided in the lip portion 2. The liquid seal with the lip of FIG. 9 substantially coincides with that disclosed in Japanese Patent No. 3180285 in a base structure.

In the pump apparatus of JP-A-2007-278086, the liquid seal with the lip is used in the backward posture, and a relief function is given to the second seal portion. That is, when pressure of the middle chamber is abnormally high (when the pressure exceeds the relief pressure), the seal lip collapses outward the diameter direction, the seal function is released, and the pressure of the middle room is discharged. For this reason, the pressure of the middle chamber does not rise in excess of the set pressure, and the damage to the liquid seal due to the abnormal pressure or the like is prevented.

### SUMMARY

When the liquid seal with the lip is attached in the forward posture, the scratching (the sweeping) leakage of oil from the sliding-contact surface to the atmosphere side is hardly generated. In the attachment of the backward posture, the scratching of oil from the sliding-contact surface to the atmosphere side occurs, and oil of the middle chamber leaks to the outside.

Since the second seal portion of the pump apparatus of JP-A-2007-278086 is used so that the liquid seal with the lip is in the backward posture as mentioned above, the relief function is included, and the sealing property drops, and for that reason, a large amount of oil of the middle chamber leaks to the outside.

In addition, in the liquid seal with the lip, commonly, when increasing a lip length 3, the leap portion is easily bent. In the case of being used in the backward posture, the relief pressure drops, and even when the liquid chamber side does not become the abnormal pressure, the liquid leaks from the seal surface. An amount of leakage is very little, but when the use time of the seal is extended, the amount of leakage exceeds an allowance value.

Furthermore, when the lip length is shortened, when the thickness of the lip portion is thickened, or when the hardness of the material rubber is increased to suppress a decline in relief pressure, the lubricity or the followability to the vibration of the rotation shaft deteriorates, and the abrasion of the seal or the liquid leakage from the seal portion is increased.

For such a reason, in regard to the liquid seal with the lip used in the backward posture, it is required that the relief pressure and the contact surface pressure of the seal are not lowered and the sealing performance (performance of liquid leakage reduction) is increased without depending on the property of the material rubber. An object of the present invention is to respond to this demand.

An aspect of the invention provides the following arrangements:

(1) A liquid seal for sealing between a rotation shaft and a shaft hole, comprising:

an annular fixing portion configured to be fixed to an inner peripheral surface of the shaft hole;

an annular lip portion including a connecting portion extending from the annular fixing portion in an axial direction of the rotation shaft, and a seal lip which is configured to slidably contact an outer periphery of the rotation shaft and is connected to the connecting portion; and

a spring configured to press the seal lip against the outer periphery of the rotation shaft, the spring is fitted onto the lip portion,

wherein the seal lip has a mountain shape in a cross section which is cut along a plane passing through the center axis of the seal, in which an edge of an apex of the mountain shape protrudes in an inner diameter direction of the rotation shaft, and

wherein in the axial direction, the pressure center of the seal lip due to the spring is disposed between the edge of the apex of the mountain shape of the seal lip and a tip end of the connecting portion.

(2) The liquid seal according to (1),

wherein a slope angle α of a lip portion tip side slope surface of the mountain shape of the seal lip and a slope angle β of a lip portion proximal end side slope surface of the mountain of the seal lip satisfy a relationship of α<β in a free state of the seal lip.

(3) The liquid seal according to (1),

wherein a grease holding lip is connected to the tip of the lip portion, and a grease pool is formed between a grease holding lip and the seal lip.

(4) A shaft seal apparatus including:

a partition member that partitions a liquid chamber and an atmosphere portion, and includes a shaft hole;

a rotation shaft that is inserted into the shaft hole and rotatably held in the partition member; and

a seal portion that is installed between the shaft hole and the rotation shaft between the liquid chamber and the atmosphere portion to seal the liquid chamber,

wherein the seal portion is configured by mounting the liquid seal between an outer peripheral surface of the rotation shaft and an inner peripheral surface of the shaft hole in the state in which the tip of the lip portion of the liquid seal is disposed at the atmosphere portion side and the fixing portion of the liquid seal is disposed at the liquid chamber side, respectively, and

wherein the liquid seal includes:

an annular fixing portion configured to be fixed to the inner peripheral surface of the shaft hole;

an annular lip portion including a connecting portion extending from the annular fixing portion in an axial direction of the rotation shaft, and a seal lip which is configured to slidably contact the outer periphery of the rotation shaft and is connected to the connecting portion; and

a spring configured to press the seal lip against the outer periphery of the rotation shaft, the spring is fitted onto the lip portion,

wherein the seal lip has a mountain shape in a cross section which is cut along a plane passing through the center axis of the seal, in which an edge of an apex of the mountain shape protrudes in an inner diameter direction of the rotation shaft, and

wherein in the axial direction, the pressure center of the seal lip due to the spring is disposed between the edge of the apex of the mountain shape of the seal lip and a tip end of the connecting portion.

(5) A pump apparatus that has a housing having a shaft hole, a liquid drawing pump received in the housing, a rotation shaft which is assembled to the shaft hole and drives the pump, and a seal portion that seals a gap between the shaft hole and the rotation shaft and partitions a suction chamber communicating with a pump suction port in the housing from an atmosphere chamber,

wherein the seal portion is configured by mounting the liquid seal between an outer peripheral surface of the rotation shaft and an inner peripheral surface of the shaft hole in the state in which the tip of the lip portion of the liquid seal is disposed at the atmosphere chamber side, and the fixing portion of the liquid seal is disposed at the suction chamber side, respectively,

the liquid seal includes:

an annular fixing portion configured to be fixed to the inner peripheral surface of the shaft hole;

an annular lip portion including a connecting portion extending from the annular fixing portion in an axial direction of the rotation shaft, and a seal lip which is configured to slidably contact the outer periphery of the rotation shaft and is connected to the connecting portion; and

a spring configured to press the seal lip against the outer periphery of the rotation shaft, the spring is fitted onto the lip portion,

wherein the seal lip has a mountain shape in a cross section which is cut along a plane passing through the center axis of the seal, in which an edge of an apex of the mountain shape protrudes in an inner diameter direction of the rotation shaft, and

wherein in the axial direction, the pressure center of the seal lip due to the spring is disposed between the edge of the apex of the mountain shape of the seal lip and a tip end of the connecting portion.

(6) The pump apparatus according to (5), wherein

a first seal portion, which is disposed between a middle chamber and a suction chamber and seals a liquid leakage from the suction chamber to the middle chamber in a gap between the inner peripheral surface of the shaft hole and the outer peripheral surface of the rotation shaft, is provided between the suction chamber and the atmosphere chamber, and

the seal portion constituted by the liquid seal is disposed between the middle chamber and the atmosphere chamber.

Since, in the liquid seal of the present invention, the pressure center of the seal lip due to a spring tightening the seal lip is disposed between the tip side of the lip portion and the edge of the apex of the mountain of the seal lip in the axial direction, the seal lip tightened by force of the spring is obliquely pressed from the tip side of the lip portion to the rotation shaft in a direction facing the proximal end side.

As a result, the ability of the lip portion to resist against the liquid pressure of the liquid chamber is increased, whereby it is suppressed that the seal pressure (the contact surface pressure of the seal lip to the rotation shaft) deteriorates due to the liquid pressure.

Furthermore, regarding the contact situation of the seal relative to the rotation shaft at this time, the peak point of the contact surface pressure is located to the proximal side of the lip portion more than the pressure center of the seal lip due to the spring, and the lip contact region to the rotation shaft is increased at the atmosphere portion side and reduced at the liquid chamber side by setting the peak point as a boundary. For this reason, a surface pressure fluctuation (a change in surface pressure from the peak point to the position of the surface pressure of zero) on the contact surface of the atmosphere portion side further than the peak point is relieved compared to the surface pressure fluctuation of the contact surface of the liquid chamber side contact surface more than the peak point.

Due to the surface pressure distribution, the sealing property of the seal portion is further increased, and the amount of leakage from the fluid chamber to the atmosphere portion is reduced. A mechanism of the liquid leakage reduction at this time is considered to be that, by the surface pressure distribution, air is easily sucked from the atmosphere side on the seal interface of the atmosphere portion side further than the peak point, and the same phenomenon occurs in which air is slightly sucked from the atmosphere side to the seal interface when using the general liquid seal with the lip in the forward posture, and the oil film of the sliding interface is not pushed back such as being scraped to the atmosphere portion side.

Furthermore, since the liquid seal of the present invention is used in the backward posture as mentioned above, the liquid seal cannot be used in the forward posture and the relief function is ensured. Additionally, since the spring is offset disposed to generate the effect mentioned above, a drop in contact surface pressure or a drop in relief pressure is also not caused.

In addition, in regard to a slope angle of α slope surface of the mountain of a free state of the seal lip, when setting a slope angle β of a lip portion proximal end side slope surface to be greater than a slope angle α of a lip portion tip side slope surface, the deviation of the surface pressure distribution to the liquid chamber side of the peak point is remarkable compared to the case of α=β, and the effect of the liquid leakage reduction is higher.

When a grease holding lip is provided in the lip portion, the maintenance time of the lubrication performance of the atmosphere portion side is extended, and the holding stability of the spring can also be increased. By interposing grease having viscosity higher than liquid of the liquid chamber in the seal interface, an effect of the leakage reduction is also enhanced. Furthermore, since the maintenance stability of the spring is enhanced, it is possible to increase force (load) of the spring and to enhance the relief pressure further than in a case where the grease holding lip does not exist.

The shaft seal apparatus of the present invention can enhance the sealing property (performance of leakage prevention) due to the seal while obtaining the relief function by using the liquid seal with the lip in the backward posture.

Additionally, the pump apparatus of the present invention can reduce the amount of leakage of oil or the like from a housing. In the pump apparatus disclosed in JP-A-2007-278086, the liquid pressure generated in a master cylinder flows in a suction chamber, and the sliding seal of the first seal portion is moved to the middle chamber side by the pressure, whereby there is a possibility that the pressure of the middle chamber may rise. However, in the pump apparatus of the present invention, even if such a situation occurs, when the pressure of the middle chamber is equal to or less than the relief pressure, the leakage of liquid can be reduced.

Additionally, when the pressure of the middle chamber is abnormally increased in excess of the relief pressure, it is possible to exhibit the relief function and to prevent the damage to the liquid seal due to the abnormal pressure or the like.

### BRIEF DESCRIPTION OF THE DRAWINGS

FIG. 1 is a cross-sectional view that shows an example of a liquid seal of the present invention.

FIG. 2 is a cross-sectional view of a shaft seal apparatus using a liquid seal of FIG. 1.

FIG. 3 is a diagram that shows a surface pressure distribution of a seal lip contact portion to a rotation shaft.

FIG. 4 is a cross-sectional view that shows another example of a liquid seal of the present invention.

FIG. 5 is a cross-sectional view that shows an example of a pump apparatus of the present invention.

FIG. 6 is a cross-sectional view that shows a use state when force of a spring of the liquid seal of FIG. 1 is increased.

FIG. 7 is a cross-sectional view that shows a use state of the liquid seal of FIG. 4 by jointly describing a surface pressure distribution of the seal lip contact portion.

FIG. 8 is a diagram that shows a size specification of the liquid seal manufactured as a trial.

FIG. 9 is a cross-sectional view that shows a liquid seal of the related art.

### DESCRIPTION OF EXEMPLARY EMBODIMENTS

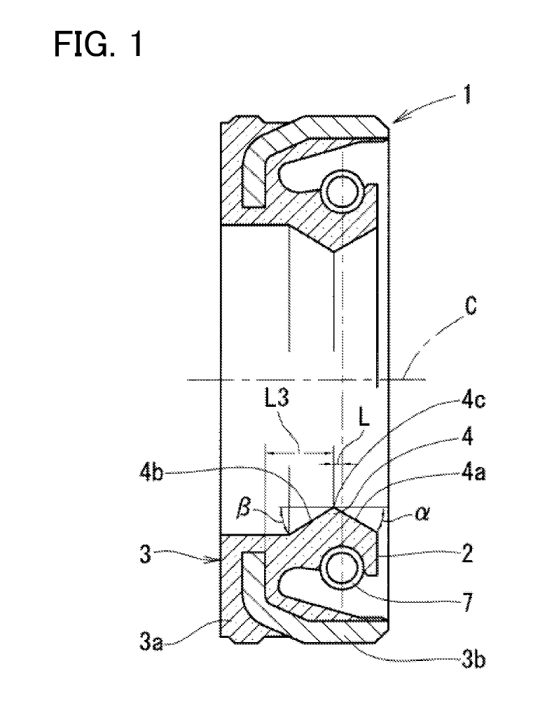

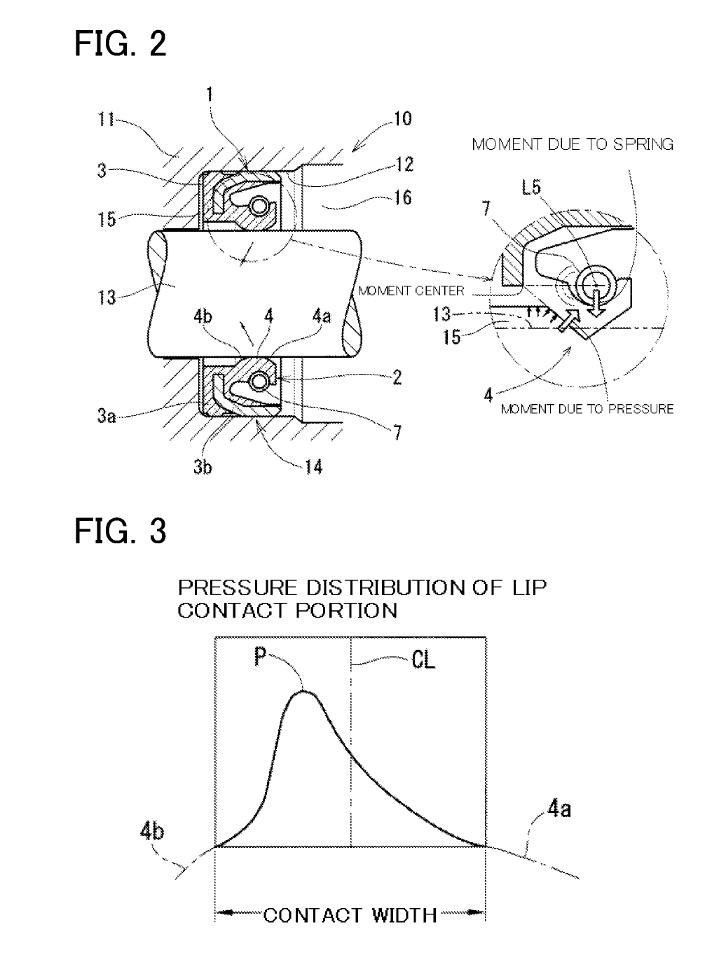

Hereinafter, a liquid seal, a shaft seal apparatus and a pump apparatus using the same according to the exemplary embodiment will be described based on FIGS. 1 to 8 of the accompanying drawings. FIG. 1 shows an example of a liquid seal. Furthermore, FIG. 2 shows a shaft seal apparatus using the liquid seal of FIG. 1.

A liquid seal 1 of FIG. 1 includes an annular lip portion 2 that slidably contacts an outer periphery of a rotation shaft 13 (see FIG. 2), an annular fixing portion 3 that is fixed to an inner peripheral surface of a shaft hole into which the rotation shaft 13 is inserted, and an annular spring 7 that is fitted onto the lip portion 2.

Additionally, a second shaft seal apparatus 10 includes a partition member 11 such as a housing that partitions a liquid chamber 15 and an atmosphere portion 16, a rotation shaft 13 that is inserted in to a shaft hole 12 provided in the partition member 11 and is held in the partition member 11, and a seal portion 14 that is provided between the shaft hole 12 and the rotation shaft 13 to seal the liquid chamber 15. The seal portion 14 is configured by disposing the liquid seal 1 of FIG. 1 in the state in which the fixing portion 3 is at the liquid chamber 15 side, and the tip of the lip portion 2 is at the atmosphere portion 16 side of the lip portion 2, respectively.

The lip portion 2 of the liquid seal 1 of FIG. 1 is provided so that a proximal end is connected to an inner end of one surface side of the fixing portion 3 in a diameter direction, and the tip thereof is extended from the connection portion in an axial direction. The fixing portion 3 of the seal as shown is configured so that a reinforcement annulus 3b (this is provided as the need arises) formed of cold-rolling steel or the like is embedded in a seal main body 3a formed of an elastic material. The lip portion 2 integrally formed using the same material as the seal main body 3a has a seal lip 4 that is tightened to the spring 7 and is pressed to the outer periphery of the rotation shaft.

The seal main body 3a and the seal lip 4 are formed of the same elastic material as a general liquid seal, that is, synthetic rubber such as fluorine rubber, acryl rubber, nitrile rubber, silicone rubber, and urethane rubber, a composite material such as TPE, rubber-plastic and rubber-filling material, or the like.

The seal lip 4 has a mountain shape in which an edge 4c of the apex protrudes to an inner diameter side, in a cross section in which the liquid seal 1 is cut along a plane passing through a center axis C of the seal. A slope angle of a slope surface of the mountain in the free state of the seal lip 4, that is, a slope angle α of a slope surface 4a of the lip portion tip side, and a slope angle β of a slope surface 4b of the lip portion proximal end side are set as α<β.

The slope angle α of the slope surface 4a of the lip portion tip side is about 15° to 30°, and the slope angle β of the slope surface 4b of the lip portion proximal end side is about 25° to 40°.

Herein, a garter spring is adopted as the spring 7, but the spring is not limited to the garter spring. The seal lip 4 may be tightened inward in the diameter, and a rubber ring integral with or separated from the seal lip, a ring-shaped crimp spring or the like can be used.

The spring 7 is disposed between the tip side (right side in FIG. 1) of the lip portion 2 and the edge 4c of the apex of the seal lip 4. Namely, the pressure center CL of the seal lip 4 due to the spring 7 is disposed between the tip side (right side in FIG. 1) of the lip portion 2 and the edge 4c of the apex of the seal lip 4.

A distance from the edge 4c of the apex of the seal lip 4 to the pressing center CL according to the spring 7, that is, an offset amount L of the spring 7 shown in FIG. 1 depends on the diameter of the rotation shaft 13, the hardness of the material rubber constituting the liquid seal 1 or the like, but, for example, in the case of being used in the outer peripheral seal of the rotation shaft not having the diameter of 10 mm, it is confirmed that, even with a small value having an offset amount L of 0.2 mm, a sufficient effect can be expected.

In the case of constituting the shaft seal apparatus 10 of FIG. 2 using the liquid seal 1, when the internal pressure of the liquid chamber 15 is high, a moment is received in a direction in which the seal lip 4 is separated from the rotation shaft 13 around the moment center near an inner diameter side end portion (see FIG. 2) of a reinforcement annulus 3b of the liquid seal 1. Meanwhile, the spring 7 stretches an elbow length L5 from the moment center by the offset disposition and adds the moment of the opposite direction to the seal lip 4. Thus, as compared to the case of using the general liquid seal with the lip of the related art in the backward posture, the capacity for resisting the liquid pressure of the liquid chamber is enhanced, and a drop in seal pressure due to the liquid pressure is suppressed.

Furthermore, by the offset disposition mentioned above, a peak point P of the surface pressure of the seal lip contact portion is located to the proximal end side of the lip portion 2 as shown in FIG. 3, that is, to the left side in FIG. 2, air is easily sucked from the atmosphere portion to the seal interface, the push-back of the fluid film of seal interface to the liquid chamber side due to the suction air can also be expected, and the leakage is reduced by a synergistic effect as above.

When the internal pressure of the liquid chamber 15 is increased in excess of a predetermined value, the lip portion 2 is elastically deformed so as to reach the outside in the diameter direction, whereby a relief function is ensured in which an abnormal pressure in the liquid chamber 15 is discharged.

Herein, in the liquid seal 1 of the present invention, a ratio is increased in which the seal lip 4 comes into contact with the rotation shaft 13 at the atmosphere portion side, by offset-disposing the spring 7 at the tip side of the lip portion, compared to the case where the offset amount is zero or the offset is in the opposite direction of the present invention. When the amount of leakage of liquid (oil such as a brake fluid) is reduced in that situation, the lubrication effect of the sliding surface due to the leaked liquid is reduced. Thus, in the liquid seal used for a long time, a countermeasure for that problem may be provided.

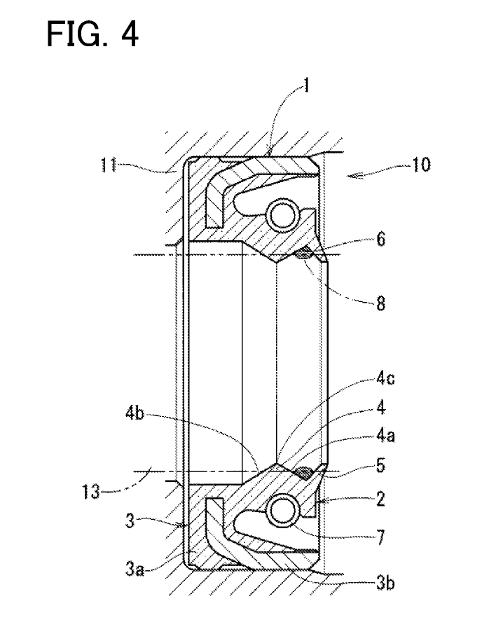

The liquid seal 1 of FIG. 4 answers the demand thereof. The liquid seal 1 of FIG. 4 provides the greases holding lip 5 in the tip of the lip portion 2, and forms a grease pool 6 between the grease holding lip 5 and the seal lip 4. The liquid seal 1 of FIG. 4 enhances the lubrication performance of the sliding surface of the atmosphere portion side when the grease 8 held in the grease pool 6 is used for a long time. Furthermore, by interposing the grease having the viscosity higher than liquid of the liquid chamber in the seal interface, the effect of liquid leakage reduction is further enhanced.

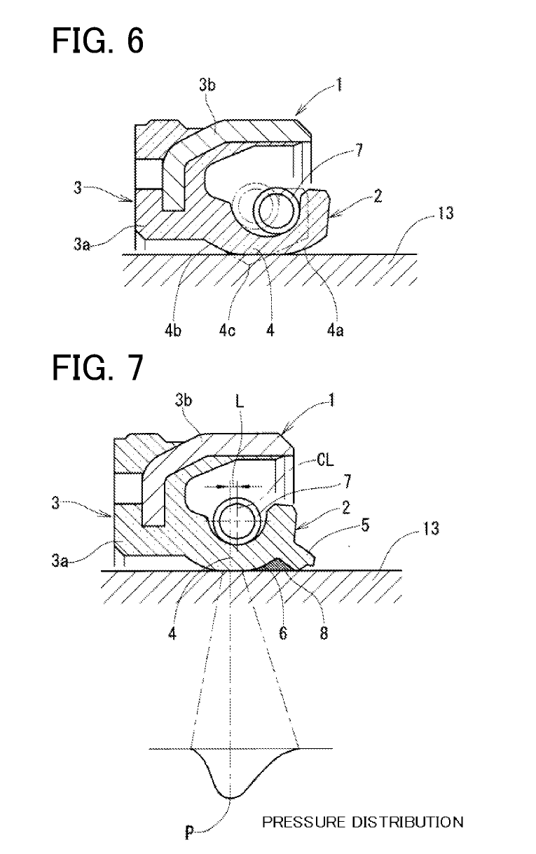

Furthermore, in the liquid seal of the present invention, in the assembled state, the seal lip 4 is brought down using the proximal end side of the lip portion 2 as the fulcrum, and is slightly moved from a position of the free time to the outside in the diameter direction. In that situation, when the free end side of the lip portion 2 is tightened to the spring 7, as shown by a solid line in FIG. 6, the position of the spring 7 deviates from a normal attachment position shown by an alternate long and short dashed line to the tip side of the lip portion 2, whereby the holding stability of the spring 7 becomes worse. The greater the force (the tightening load) of the spring 7, the more remarkable this phenomenon is.

To solve this problem, as shown in FIG. 7, in the liquid seal provided with the grease holding lip 5, the grease holding lip 5 is pressed against the rotation shaft 13, whereby the displacement to the inside of the diameter direction of the free end side of the lip portion 2 is suppressed, and the effect of stabilizing the holding of the spring 7 is also obtained. In this manner, the holding stability of the spring is enhanced, whereby it is also possible to increase the force (load) of the spring 7 and enhance the relief pressure further than in a case where the grease holding lip does not exist.

Since the shape of the seal lip 4 of the liquid seal 1 of FIG. 4, the disposition of the spring 7, and the like are the same as that of the liquid seal 1 of FIG. 1, the descriptions of the same portions will be omitted.

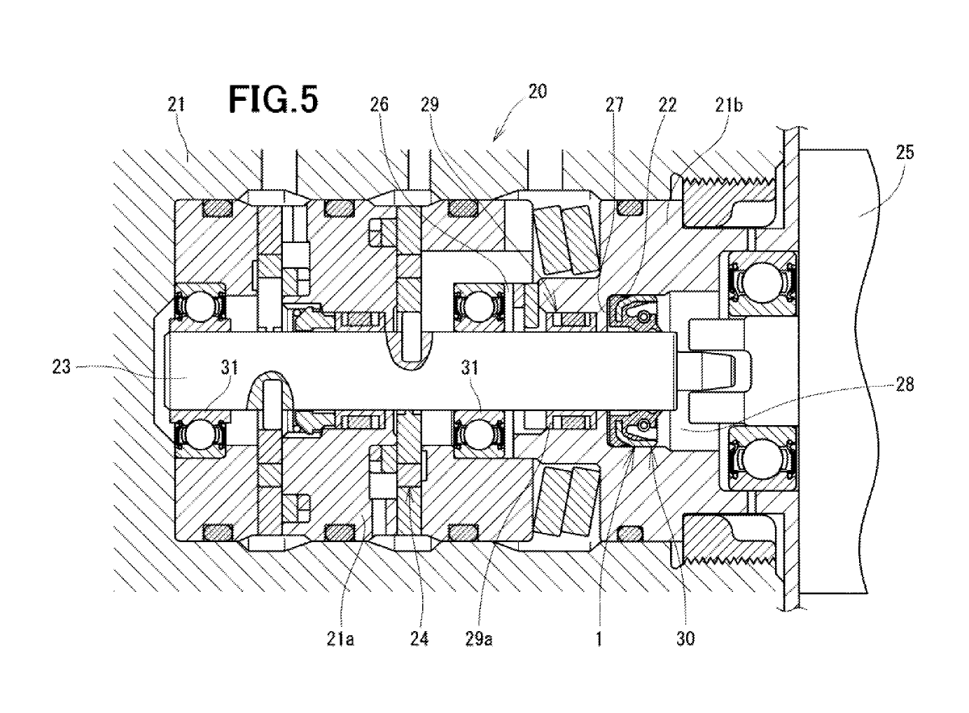

Next, an example of the pump apparatus, which seals an outer periphery of the rotation shaft using a liquid seal of the present invention, will be described based on FIG. 5. The pump apparatus 20 as shown has a housing 21 having a shaft hole 22, a liquid drawing pump 24 provided in the inner portion of the housing 21, a pump driving rotation shaft 23 assembled to the shaft hole 22, and a motor 25 that drives the rotation shaft 23. The motor 25 is fixed to the housing 21 by connecting the output shaft to the rotation shaft 23.

Furthermore, the pump apparatus 20 has a first seal portion 29 and a second seal portion 30 that partition a suction chamber 26 provided in the housing 21 from the atmosphere chamber 28 so as to seal a gap between the shaft hole 22 and the rotation shaft 23, and a middle chamber 27 that is disposed between both seal portions 29 and 30.

In the housing 21, a pump case 21a and a plug 21b are included. The pump 24 is received in the pump case 21a to constitute a pump unit, the pump unit is inserted into a reception chamber formed in the housing 21, and an inlet of the reception chamber is closed by the plug 21b.

The rotation shaft 23 is supported by a plurality of bearings 31 and is assembled to the shaft hole 22. The pump 24 to be driven by the rotation shaft 23 is provided in a known inscription gear type. The inscription gear type pump is configured so that a teeth number difference is combined by eccentrically disposing an inner rotor and an outer rotor of a tooth, and the inner rotor is rotated and driven by the rotation shaft 23. At this time, the outer rotor is subjected to the driven rotation, a volume of a pump chamber (a pumping chamber) to be formed between both of the rotors is increased, and the suction and the discharging of liquid are performed.

The suction chamber 26 communicates with a suction port of the pump 24. A first seal portion 29 installed between the suction chamber 26 and the middle chamber 27 is a known seal portion, and is constituted by disposing the seal member 29a, in which a sliding seal material formed by fluorine resin having a small friction coefficient or the like and a rubber seal are combined with each other, between the rotation shaft 23 and the shaft hole 22 formed in the plug 21b. The first seal portion 29 seals the leakage of liquid from the suction chamber 26 to the middle chamber 27.

When liquid leaks from the first seal portion 29, the leaked liquid is accumulated in the middle chamber 27. The second seal portion 30 is configured so as to hinder the leakage from the middle chamber 27 leaked to the middle chamber 27.

The second seal portion 30 is configured so that the liquid seal 1 of the present invention mentioned above is disposed between the outer periphery of the rotation shaft 23 and the inner peripheral surface of the shaft hole 22, the tip of the lip portion 2 is disposed at the atmosphere 28 side, and the fixing portion 3 is disposed at the suction chamber 26 side, respectively.

The pump apparatus 20 as shown may be considered such that the oil seal of the pump apparatus disclosed in JP-A-2007-278086 mentioned above is replaced with the liquid seal of the present invention.

The pump apparatus disclosed in JP-A-2007-278086 is used in a motor vehicle brake liquid pressure control device such as an ABS (anti-lock control) or an ESC (a motor vehicle stabilization control) which includes a braking force control function by the electronic control, and, in the application thereof, the liquid pressure generated in the master cylinder flows to the suction chamber 26.

Furthermore, the seal member 29a of the first seal portion 29 is moved to the middle chamber 27 by the liquid pressure flowed in at this time, and the pressure of the middle chamber 27 is unnecessarily increased. The liquid seal 1 of the present invention shows effectiveness under such a situation, whereby it is possible to reduce the leakage of brake fluid from the middle chamber 27 while obtaining the relief function.

In addition, the description mentioned above was performed by describing the pump apparatus using the inscription gear as an example, but the pump apparatus, to which the present invention is applied, may be driven by the rotation shaft. A vane pump, a circumscription gear type pump or the like is also an application target.

### Example

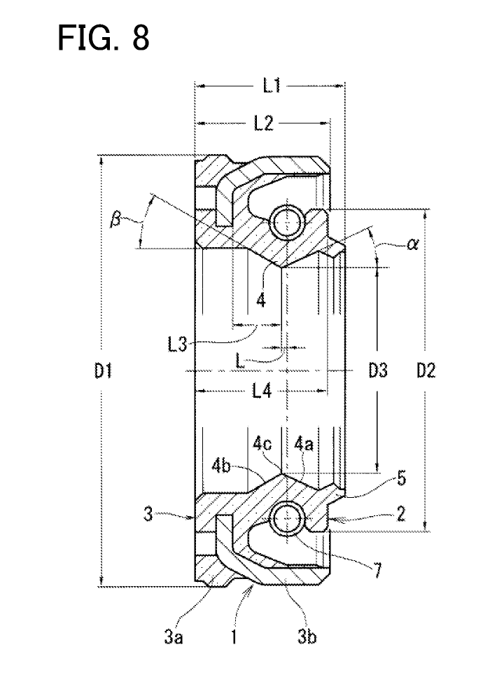

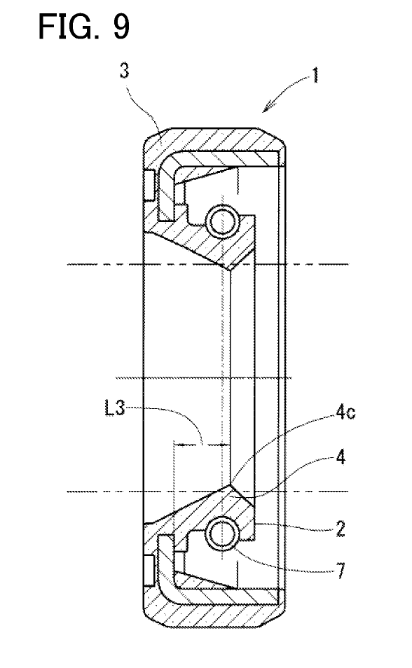

A sample of the liquid seal 1 of FIG. 4 was manufactured. The sizes of parts shown in FIG. 8 of the liquid seal 1 are described as follows:

Sizes of the Liquid Seal 1

An outer diameter D1: φ 14 mm, a whole length L1: 5 mm, a fixing portion length L2: 4.5 mm, a lip length L3: 1.6 mm, a distance from the fixing end portion to the lip portion tip L4: 4.5 mm, a lip portion outer diameter D2: φ 10 mm, a lip portion diameter D3: φ 6 mm, a slope angle α of a lip portion tip side slope surface of the seal lip: 25°, a slope angle β of a lip portion proximal end side slope surface 4b: 30°, an offset amount of the spring 7 L: 0.2 mm

The outer periphery of the pump driving rotation shaft having a diameter of φ 7 mm provided in the pump apparatus of FIG. 5 was sealed by the use of the liquid seal (a trial product 1) of the above specification, and the liquid seal (a trial product 2) having an offset amount L of 0.3 mm and the same dimensions as those of the trial product 1 in other respects. The liquid seal of this time was of course disposed in the backward posture mentioned above.

In that situation, the pump was driven to examine the leakage condition of the brake fluid from the middle chamber 27 of FIG. 5 to the atmosphere chamber 28, with the result that the leakage was also reduced compared to the product of the related art (the spring is disposed between the proximal end side of the lip portion and the edge on the apex of the mountain of the seal lip) in the trial products 1 and 2. In addition, the cut-off of the leakage was performed by confirming the bleeding situation with eyes.

What is claimed is:

1. A liquid seal for sealing between a rotation shaft and a shaft hole, comprising:
an annular fixing portion configured to be fixed to an inner peripheral surface of the shaft hole;
an annular lip portion including a connecting portion extending from the annular fixing portion in an axial direction of the rotation shaft, and a seal lip which is configured to slidably contact an outer periphery of the rotation shaft and is connected to the connecting portion; and
a spring configured to press the seal lip against the outer periphery of the rotation shaft, the spring is fitted onto the lip portion,
wherein the seal lip has a mountain shape in a cross section which is cut along a plane passing through the center axis of the seal, in which an edge of an apex of the mountain shape protrudes in an inner diameter direction of the rotation shaft, and
wherein in the axial direction, the pressure center of the seal lip due to the spring is disposed between the edge of the apex of the mountain shape of the seal lip and a tip end of the connecting portion.

2. The liquid seal according to claim 1,
wherein a slope angle α of a lip portion tip side slope surface of the mountain shape of the seal lip and a slope angle β of a lip portion proximal end side slope surface of the mountain of the seal lip satisfy a relationship of α<β in a free state of the seal lip.

3. The liquid seal according to claim 1,
wherein a grease holding lip is connected to the tip of the lip portion, and a grease pool is formed between a grease holding lip and the seal lip.

4. A shaft seal apparatus including:
a partition member that partitions a liquid chamber and an atmosphere portion, and includes a shaft hole;
a rotation shaft that is inserted into the shaft hole and rotatably held in the partition member; and
a seal portion that is installed between the shaft hole and the rotation shaft between the liquid chamber and the atmosphere portion to seal the liquid chamber,
wherein the seal portion is configured by mounting the liquid seal between an outer peripheral surface of the rotation shaft and an inner peripheral surface of the shaft hole in the state in which the tip of the lip portion of the liquid seal is disposed at the atmosphere portion side and the fixing portion of the liquid seal is disposed at the liquid chamber side, respectively, and
wherein the liquid seal includes:
an annular fixing portion configured to be fixed to the inner peripheral surface of the shaft hole;
an annular lip portion including a connecting portion extending from the annular fixing portion in an axial direction of the rotation shaft, and a seal lip which is configured to slidably contact the outer periphery of the rotation shaft and is connected to the connecting portion; and
a spring configured to press the seal lip against the outer periphery of the rotation shaft, the spring is fitted onto the lip portion,
wherein the seal lip has a mountain shape in a cross section which is cut along a plane passing through the center axis of the seal, in which an edge of an apex of the mountain shape protrudes in an inner diameter direction of the rotation shaft, and
wherein in the axial direction, the pressure center of the seal lip due to the spring is disposed between the edge of the apex of the mountain shape of the seal lip and a tip end of the connecting portion.

5. A pump apparatus that has a housing having a shaft hole, a liquid drawing pump received in the housing, a rotation shaft which is assembled to the shaft hole and drives the pump, and a seal portion that seals a gap between the shaft hole and the rotation shaft and partitions a suction chamber communicating with a pump suction port in the housing from an atmosphere chamber,
wherein the seal portion is configured by mounting the liquid seal between an outer peripheral surface of the rotation shaft and an inner peripheral surface of the shaft hole in the state in which the tip of the lip portion of the liquid seal is disposed at the atmosphere chamber side, and the fixing portion of the liquid seal is disposed at the suction chamber side, respectively,
the liquid seal includes:
an annular fixing portion configured to be fixed to the inner peripheral surface of the shaft hole;
an annular lip portion including a connecting portion extending from the annular fixing portion in an axial direction of the rotation shaft, and a seal lip which is configured to slidably contact the outer periphery of the rotation shaft and is connected to the connecting portion; and
a spring configured to press the seal lip against the outer periphery of the rotation shaft, the spring is fitted onto the lip portion,
wherein the seal lip has a mountain shape in a cross section which is cut along a plane passing through the center axis of the seal, in which an edge of an apex of the mountain shape protrudes in an inner diameter direction of the rotation shaft, and
wherein in the axial direction, the pressure center of the seal lip due to the spring is disposed between the edge of the apex of the mountain shape of the seal lip and a tip end of the connecting portion.

6. The pump apparatus according to claim 5, wherein
a first seal portion, which is disposed between a middle chamber and a suction chamber and seals a liquid leakage from the suction chamber to the middle chamber in a gap between the inner peripheral surface of the shaft hole and the outer peripheral surface of the rotation shaft, is provided between the suction chamber and the atmosphere chamber, and
the seal portion constituted by the liquid seal is disposed between the middle chamber and the atmosphere chamber.
